(19) United States
(12) Patent Application Publication
(10) Pub. No.: US 2009/0141414 A1
(43) Pub. Date: Jun. 4, 2009

(54) Protection circuit for electric power of a car

(76) Inventors: Chin Wei Hsu, Hsinchu City (TW); Ming Hung Huang, Jhunan Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/292,647

(22) Filed: Nov. 24, 2008

(30) Foreign Application Priority Data
Nov. 30, 2007 (TW) 96145545

(51) Int. Cl. H02H 9/04

(52) U.S. Cl. 361/56

(57) ABSTRACT

A protection circuit for power of a car is located between an output terminal of a car power and a car's electronic device input terminal. The protection circuit includes a transient voltage suppressing diode, a diode, and a filtering circuit. The two terminals of the transient voltage suppressing diode are connected with the output terminal of car power. The diode is connected with the transient voltage suppressing diode and the output terminal of car power. The filtering circuit is connected with the diode and the car's electronic device input terminal. Thereby, the transient voltage suppressing diode of the present invention clamps the ripple at a safe voltage to assure the life of the car's electronic device. Furthermore, the transient voltage suppressing diode and the filtering circuit can prevent the car's electronic device from being interfered and damaged due to the ESD. The reliability of the electronic device is enhanced.

### BACKGROUND OF THE INVENTION

1. Field of the Invention

The present invention relates to a protection circuit. In particular, this invention relates to a protection circuit that suppresses the power ripple and the Electrostatic Discharge (ESD) for electric power of a car.

2. Description of Related Art

The transient status interference of the voltage and the current usually damages the electronic circuit and the device. The interference usually is generated by the turn-on operation and turn-off operation of an electrical power device, a lightening strike, ESD or the like. Transient status interference can occur anywhere and at any time. Electronic components in a car can be subject to interference caused by the transient of voltage and current. Due to this interference, the car electronic devices may operate abnormally or become damaged.

In order to overcome the interference, some methods are developed. Reference is made FIG. 1, which shows a schematic diagram of the protection circuit for the electric power of a car of the prior art. The protection circuit is located between a car power 10 and the car's electronic device 20. A fuse F1 is used for suppressing the abnormal transient status interference of the voltage and the current. When the interference makes the current flowing through the fuse F1 surpass the rating value of the fuse F1, the fuse F1 automatically burns down to prevent the car's electronic device 20 from being damaged.

The capacitor C1 in FIG. 1 has a voltage-clamping function. Because the capacitor usually is an electrolysis capacitor with large capacity, the capacitor usually is connected with a Zener diode in parallel to prevent the voltage-clamping function of the capacitor C1 from becoming worse due to the capacitor C1 is aged.

However, the method disclosed in FIG. 1 uses a fuse F1 to avoid the damage caused by the over-voltage or the over-current. When the fuse F1 burns down, the fuse F1 cannot be used again. The user needs to replace the fuse. If the fuse is not replaced, the car's electronic device 20 cannot be normally operated.

### SUMMARY OF THE INVENTION

One particular aspect of the present invention is to provide a protection circuit for electric power of a car that uses a transient voltage suppressing diode to rapidly suppress the power ripple. Therefore, the protection circuit is still good even though a lot of power ripples occurs in the protection circuit. The electronic element does not need to be replaced.

The protection circuit for electric power of a car is located between an output terminal of a car power and the car's electronic devices input terminal. The protection circuit for electric power of a car includes a transient voltage suppressing diode, a diode, and a filtering circuit. The two terminals of the transient voltage suppressing diode respectively are connected with the output terminal of a car power. The anode of the diode is connected with one terminal of the transient voltage suppressing diode and the positive terminal of the output terminal of a car power. The filtering circuit is connected with the cathode of the diode and the car's electronic device input terminal.

The present invention also discloses another protection circuit for electric power of a car. The protection circuit for electric power of a car is located between an output terminal of a car power and the car's electronic device input terminal. The protection circuit for electric power of a car includes a diode, a transient voltage suppressing diode, and a filtering circuit. The anode of the diode is connected with the positive terminal of the output terminal of a car power. The cathode of the transient voltage suppressing diode is connected with the cathode of the diode. The anode of the transient voltage suppressing diode is connected with the reference grounding terminal of the output terminal of a car power. The filtering circuit is connected with the cathode of the diode and the car's electronic device input terminal.

By using the above method, the present invention connects the transient voltage suppressing diode with the output terminal of a car power to clamp the power ripple generated from the car's electric power within an acceptable range. Thereby, the car's electronic device is not been damaged due to the power ripple. Furthermore, the diode is used for protecting the electric instruments in a car from receiving the wrong voltage due to the poles of a car battery being inverted, and the filtering circuit can suppress the ESD.

For further understanding of the invention, reference is made to the following detailed description illustrating the embodiments and examples of the invention. The description is only for illustrating the invention and is not intended to limit of the scope of the claim.

### BRIEF DESCRIPTION OF THE DRAWINGS

The drawings included herein provide a further understanding of the invention.

A brief introduction of the drawings is as follows:

FIG. 1 is a schematic diagram of the protection circuit for the electric power of a car of the prior art;

FIG. 2 is a schematic diagram of the protection circuit for the electric power of a car of the preferred embodiment of the present invention;

FIG. 3A is a schematic diagram of the operation of the protection circuit in FIG. 2 under a normal input voltage;

FIG. 3B is a schematic diagram of the operation of the protection circuit in FIG. 2 under a abnormal input voltage; and

FIG. 4 is a schematic diagram of the protection circuit for the electric power of a car of the second embodiment of the present invention.

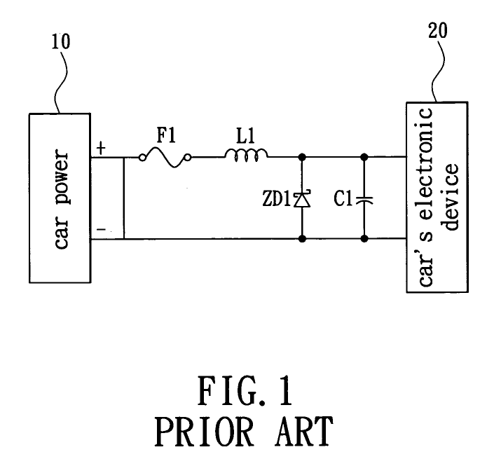

### DETAILED DESCRIPTION OF PREFERRED EMBODIMENTS

The present invention provides a protection circuit that can rapidly suppresses the power ripple and the abnormal ESD interference of the electric power outputted by a car for electric instruments in the car, and the protection circuit can be repeatedly used. The electronic protection element (such as the fuse) in the protection circuit does not need to be replaced, and it prevents the electronic elements in the car from being damaged due to the poles of the battery of the car power are connected with wrong poles.

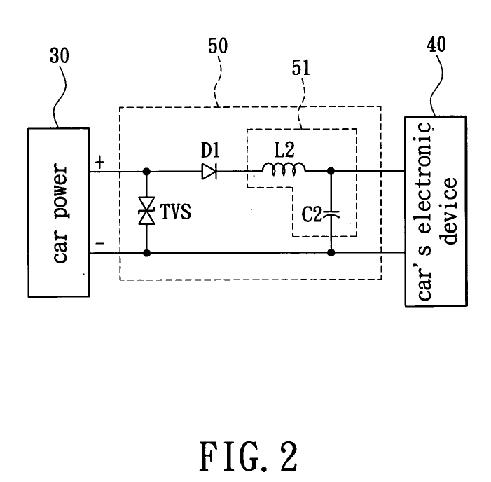

Reference is made to FIG. 2, which shows schematic diagram of the protection circuit for the car power of the preferred embodiment of the present invention. The protection circuit 50 for electric power of a car is located between a car power 30 and a car's electronic device 40 for providing a protection algorithm to the car power 30 so that the car electronic device can receive a normal and stable power and the car electronic device can be operated normally.

The protection circuit 50 for electric power of a car includes a transient voltage suppressing diode TVS, a diode D1, and a filtering circuit 51. The two terminals of the transient voltage suppressing diode TVS respectively are connected with the two terminals (the power positive terminal and the reference grounding terminal) of the output terminal of the car power 30, and one terminal of the transient voltage suppressing diode TVS is connected with the anode of the diode D1. The anode of the diode D1 also is connected with the power positive terminal of the output terminal of the car power.

The filtering circuit 51 includes a ferrite bead L2 and a capacitor C2. One terminal of the ferrite bead L2 is connected with the cathode of the diode D1 and the second terminal of the ferrite bead L2 is connected with the positive terminal of the capacitor C2. The two terminals of the capacitor C2 is connected with the input terminal of the car's electronic device 40. The negative terminal of the capacitor C2 and one terminal of the transient voltage suppressing diode TVS are connected with the reference grounding terminal of the car power 30. In this embodiment, the ferrite bead L2 can be replaced by an inductor to achieve the same effect. The two terminals of the inductor respectively are connected with the cathode of the diode D1 and the positive terminal of the capacitor C2. The transient voltage suppressing diode TVS can be divided into a unipolar type and a bipolar type. In FIG. 2, the transient voltage suppressing diode TVS is belonging to the bipolar type. Of course, the transient voltage suppressing diode TVS also can be the unipolar type. When the transient voltage suppressing diode TVS is the unipolar type, the cathode of the transient voltage suppressing diode TVS is connected with the anode of the diode, and the anode of the transient voltage suppressing diode TVS is connected with the reference grounding terminal.

By referring to FIG. 2, the protection circuit 50 uses the transient voltage suppressing diode TVS to clamp the power ripple generated from the car power at a fixed voltage, utilizes characteristics of the diode, including the forward conduction and backward cut off, to prevent the battery of the car power from being connected with the wrong poles, uses the filtering circuit 51 to filter the noise interference when the car power is transmitted, and uses the ferrite bead L2 and the capacitor C2 to suppress the transient status current of the ESD. In this embodiment, the present invention uses the transient voltage suppressing diode TVS and the filtering circuit 51 to suppress the power ripple and prevent the car's electronic device 40 from being interfered and damaged due to ESD. The reliability of the electronic device is enhanced.

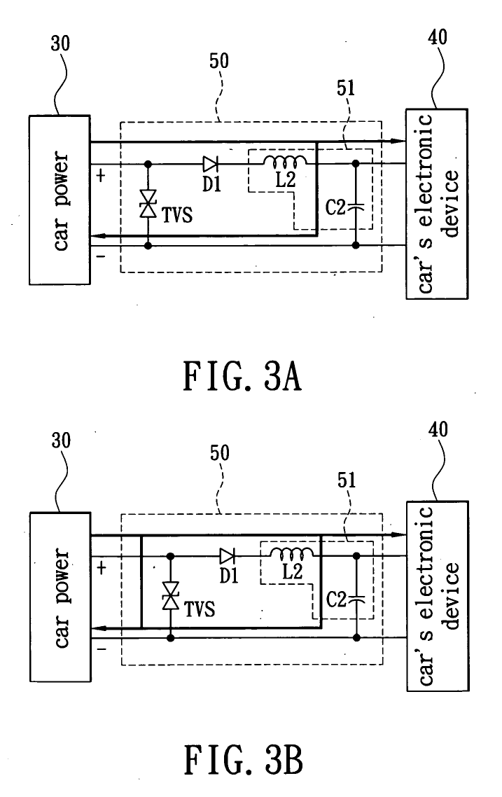

The operations of the circuit in FIG. 2 are shown in FIGS. 3A and 3B. FIG. 3A shows the operation when the car power 30 does not have the power ripple. At this time, the transient voltage suppressing diode TVS does not be operated and can be treated as a turn-off status. Therefore, the output power of the car power 30 can be directly conducted by the diode D1, flows to the filtering circuit 51 and reaches the reference grounding terminal to form a conducted power loop. The required power of the car's electronic device 40 is provided from the filtering circuit composed of the ferrite bead L2 and the capacitor C2, and the power is stable. The filtering circuit 51 and the transient voltage suppressing diode TVS form an ESD protection circuit. When the car power 30 is interfered by the power ripple, the operation of the protection circuit 50 is referred to FIG. 3B, the transient voltage suppressing diode TVS breaks down to be in a turn-on status due to the power ripple to clamp the voltage at a fixed and safe voltage (the safe voltage is smaller than the specification voltage of the elements in the protection circuit) until the power ripple disappears. At this time, the transient voltage suppressing diode TVS recovers to the turn-off status and the protection circuit 50 recovers to the operation status in FIG. 3A. When the transient voltage suppressing diode TVS operates, the car's electronic device 40 still can obtain the power from the safe voltage clamped by the transient voltage suppressing diode TVS.

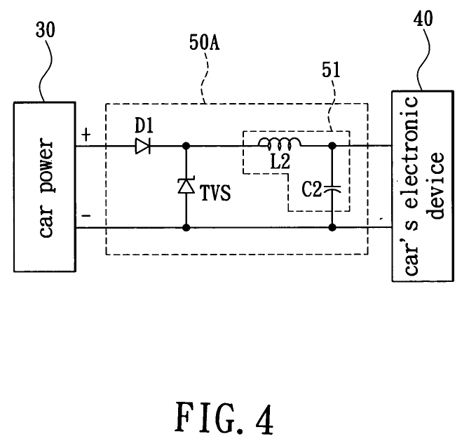

Reference is made to FIG. 4, which shows schematic diagram of the protection circuit for the car power of the second embodiment of the present invention. The transient voltage suppressing diode TVS of the protection circuit 50A in FIG. 4 is belonging to the unipolar type. The connection locations are different from FIG. 2. The two terminals of the transient voltage suppressing diode TVS are connected with the cathode of the diode D1 and the reference grounding terminal. The cathode of the transient voltage suppressing diode TVS is connected with the cathode of the diode. The anode of the transient voltage suppressing diode TVS is connected with the reference grounding terminal. The operation principle and the characteristic of the protection circuit 50A in FIG. 4 are the same as ones of the protection circuit 50 in FIG. 2. Both uses the transient voltage suppressing diode TVS to suppress the power ripple, use the diode D1 to prevent the battery of the car power from being connected with the wrong poles, and use the filtering circuit 51 to filter the noise of the car power. The implementation and the elements of the filtering circuit 51 are referred to FIG. 2.

The protection circuits disclosed at the embodiments use the transient voltage suppressing diode TVS to suppress the ripple, not the varistor. In addition to rapidly suppress the ripple, the operation characteristic of the transient voltage suppressing diode TVS will not become worse after a lot of ripples occur. The operation characteristic of the varistor becomes worse after a lot of ripples occur. Therefore, the reliability of the protection circuit is enhanced.

Moreover, the protection circuit of the present invention can pass the anti-interference test of the car electronic unit (regulated by ISO 7637). For example, the ripple interference test regulated by ISO 7637, such as pulse #1, pulse #2a, and pulse #3a/b etc. The present invention utilizes the characteristics of the transient voltage suppressing diode TVS, including rapid response and long life, to pass the ISO 7637 test.

The protection circuit of the present invention does not need to use the fuse (the electronic elements can not be used repeatedly). The protection circuit uses the transient voltage suppressing diode TVS to suppress the ripple, utilizes characteristic of the diode, the one-way conduction, to prevent the battery of the car power from being connected with the wrong poles, uses the filtering circuit to filter the noise interference of the power provided to the car electronic device, and uses the transient voltage suppressing diode TVS and the filtering circuit to prevent the car electronic device from being interfered and damaged due to ESD. The reliability of the electronic device is enhanced.

Furthermore, the protection circuit does not include the elements that will consume power, such as resistor. It uses a simple structure to form a low cost, high reliability and stable protection circuit so that the car power is not affected by the ripple to be provided to the car electronic device.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A protection circuit for electric power of a car, located between an output terminal of a car power and a car's electronic device input terminal, comprising:
a transient voltage suppressing diode, wherein two terminals of the transient voltage suppressing diode are respectively connected with the output terminal of the car power;
a diode, wherein the anode of the diode is connected with one terminal of the transient voltage suppressing diode and the positive terminal of the output terminal of the car power; and
a filtering circuit connected with the cathode of the diode and the car's electronic device input terminal.

2. The protection circuit for electric power of a car as claimed in claim 1, wherein the cathode and the anode of the transient voltage suppressing diode are respectively connected with the positive terminal and the reference grounding terminal of the output terminal of the car power.

3. The protection circuit for electric power of a car as claimed in claim 2, wherein the filtering circuit includes a ferrite bead and a capacitor, the first terminal of the ferrite bead is connected with the cathode of the diode, the first terminal of the capacitor is connected with the second terminal of the ferrite bead, the second terminal of the capacitor is connected with the reference grounding terminal of the output terminal of the car power, and the two terminals of the capacitor are connected with the car's electronic device input terminal.

4. The protection circuit for electric power of a car as claimed in claim 2, wherein the filtering circuit includes an inductor and a capacitor, the first terminal of the inductor is connected with the cathode of the diode, the first terminal of the capacitor is connected with the second terminal of the inductor, the second terminal of the capacitor is connected with the reference grounding terminal of the output terminal of the car power, and the two terminals of the capacitor are connected with the car's electronic device input terminal.

5. A protection circuit for electric power of a car, located between an output terminal of a car power and the car's electronic device input terminal, comprising:
a diode, wherein the anode of the diode is connected with the positive terminal of the output terminal of the car power;
a transient voltage suppressing diode, wherein the cathode of the transient voltage suppressing diode is connected with the cathode of the diode, and the anode of the transient voltage suppressing diode is connected with the reference grounding-terminal of the output terminal of the car power; and
a filtering circuit connected with the cathode of the diode and the car's electronic device input terminal.

6. The protection circuit for electric power of a car as claimed in claim 5, wherein the filtering circuit includes a ferrite bead and a capacitor, the first terminal of the ferrite bead is connected with the cathode of the diode, the first terminal of the capacitor is connected with the second terminal of the ferrite bead, the second terminal of the capacitor is connected with the reference grounding terminal of the output terminal of the car power, and the two terminals of the capacitor are connected with the car's electronic device input terminal.

7. The protection circuit for electric power of a car as claimed in claim 5, wherein the filtering circuit includes an inductor and a capacitor, the first terminal of the inductor is connected with the cathode of the diode, the first terminal of the capacitor is connected with the second terminal of the inductor, the second terminal of the capacitor is connected with the reference grounding terminal of the output terminal of the car power, and the two terminals of the capacitor are connected with the car's electronic device input terminal.
